(19) United States
(12) Patent Application Publication
(10) Pub. No.: US 2011/0198944 A1
(43) Pub. Date: Aug. 18, 2011

(54) CONDUCTOR ARRANGEMENT, METHOD FOR THE PRODUCTION THEREOF, AND USE OF A CONDUCTOR ARRANGEMENT

(75) Inventor: Folkert Kassen, Lahnau-Atzbach (DE)

(73) Assignee: ITK DR. KASSEN GMBH, Lahnau (DE)

(21) Appl. No.: 13/124,108

(22) PCT Filed: Oct. 7, 2009
(86) PCT No.: PCT/EP09/63008

§ 371 Date: Apr. 13, 2011

(30) Foreign Application Priority Data
Oct. 22, 2008 (DE) 10 2008 052 627.4

(51) Int. Cl. H02K 41/02; H02K 15/00

(52) U.S. Cl. 310/12.22; 29/596

(57) ABSTRACT

The invention relates to a conductor arrangement (10), to a method for the production thereof, and to a method for using a conductor arrangement, wherein the conductor arrangement for an electric machine, particularly an electric motor, can be moved relative to magnetically active components of the electric machine, wherein the conductor arrangement comprises at least one electrical conductor (12, 13, 14, 15) and a carrier (11) for spatially positioning the conductor, wherein the conductor comprises at least one conductor strand (18, 19, 20, 21) and is arranged in the manner of a coil, and wherein the conductor strand comprises conductor sections (27, 28, 29, 30) that are arranged, at least in sections, perpendicular and parallel to a direction of motion of the carrier or the components, and wherein at least one outer conductor section (27, 28) arranged parallel to the direction of motion has a cross section that is larger than the cross section of the other conductor sections (29, 30).

The invention relates to a conductor arrangement, a method for the production thereof and a use of a conductor arrangement, wherein the conductor arrangement for an electric machine, in particular an electric motor, can be moved relative to magnetically active components of the electric machine, wherein the conductor arrangement comprises at least one electrical conductor and a carrier for spatially positioning the conductor, wherein the conductor comprises at least one conductor strand (18, 19, 20, 21) and is arranged in the manner of a coil, and wherein the conductor strand comprises conductor sections that are arranged, at least in sections, crosswise and parallel to a direction of motion of the carrier or the components.

Such conductor arrangements are sufficiently known and are applied in particular in electric motors or generators as a component of a stator or rotor, or as a translationally moveable component. Coils of the conductor arrangement serve to generate a magnetic field, which can be moved relative to a further magnetic field and so facilitates a conversion of electrical energy into a motion or a conversion of a motion into electrical energy. Since the coil has current flowing through it, heating occurs in the coil due to its material resistance. In particular when the electrical machine is operated under continuous load the conductor arrangement can heat up to such an extent that a coil is destroyed. A continuous power of the electrical machine is therefore limited among other things by a maximum temperature of the conductor arrangement which does not lead to destruction of the conductor arrangement, wherein the maximum temperature is dependent on the current density passed through the conductor arrangement. If air cooling of the conductor arrangement or coils takes place, effected by means of rotation or movement, the current density and therefore the continuous power of the electrical machine can be increased.

Cooling is particularly difficult in cases where the conductor arrangement is a component of a linear or torque motor. Frequently these motors comprise magnetically active components, that are arranged on one or both sides of the conductor arrangement. Thus U-shaped magnets, for example, or similar arrangements of magnets are applied, in the intermediate space of which the conductor arrangement is moved. To achieve high efficiency levels, a distance between the conductor arrangement and the magnetically active components is kept comparatively small in size. Since these motors advantageously facilitate a relatively small constructional form, it is desirable to miniaturise the conductor arrangement as much as possible. Thus improved dynamic properties of the motors can also be obtained, by virtue of weight savings. The motors of this type known from the prior art therefore use conductor arrangements that are formed from a plurality of wound coils arranged in series next to each other, wherein the coils are accommodated and mounted in a dielectric casting material or a plastic. Therefore a comparatively compact design of the conductor arrangement is possible with a relatively large magnetically active surface.

In this arrangement however, cooling of the conductor arrangement is particularly difficult to obtain, since a gap between the conductor arrangement and the magnetically active components relative to the magnetically active surface is very small, so that barely any air can circulate in the gap. The casting material also prevents a direct cooling of the coils, so that at high temperatures a short circuit of a conductor or a deformation of the casting material, and therefore damage to the conductor arrangement, can result. From the prior art therefore, to obtain a higher continuous power it is known to cool such motors or their conductor arrangements with additional fan arrangements or cooling conductors, which are cast together with the coils. In each case an indirect cooling of the coils takes place, wherein the casting material in particular has a comparatively poor thermal conductivity relative to the metallic conductor. In particular with cooling techniques that are arranged in an edge region of the conductor arrangement which is used for mounting the conductor arrangement, for heat dissipation, a relatively high temperature gradient is produced between the edge region and a covering region of the conductor arrangement with the magnetically active components. While the cooling conductors that are cast with the coils do facilitate an improvement here, it means however that less space is available, in relation to a cross section of the conductor arrangement, for the construction of coils and also the conductor arrangement is liable to maintenance and relatively expensive to produce.

The object of the invention therefore is to propose a conductor arrangement, a method for producing a conductor arrangement and a use of a conductor arrangement, which facilitate or facilitates a simple dissipation of heat energy away from the conductor arrangement.

This object is achieved by a device with the features of claim 1, a production method with the features of claim 17 and a method of use with the features of claim 22.

The conductor arrangement according to the invention for an electrical machine, in particular an electric motor, can be moved relative to magnetically active components of the electrical machine, wherein the conductor arrangement is formed from at least one electrical conductor and one carrier for spatially positioning the conductor, wherein the conductor comprises at least one conductor strand and is arranged in the manner of a coil, wherein the conductor strand comprises conductor sections that are arranged, at least in sections, crosswise and parallel to a direction of motion of the carrier or the components, and wherein at least one outer conductor arranged parallel to the direction of motion has a cross section that is greater than the cross section of the remaining conductor sections. Since the cross section of the outer conductor section is comparatively greater than the cross section of the remaining conductor sections a concentration of heat energy of the conductor arrangement is facilitated in an edge region parallel to the direction of motion. Because a suitable mounting of the conductor arrangement is required in an edge region of the conductor arrangement in any case, the heat energy can be easily conducted away from the edge region of the conductor arrangement. The advantageous concentration of the heat energy can be achieved in particular by the fact that, on account of the greater cross section and consequently a larger mass, a thermal capacity of the outer conductor section is greater than a thermal capacity of the remaining conductor sections. In the event of the conductor sections being heated up, a temperature gradient is produced between the outer conductor section and the remaining conductor sections, which effects a flow of heat into the outer conductor section. The outer conductor section therefore serves to conduct heat energy away from the remaining conductor sections and hence to provide direct cooling of the conductor sections through the conductor sections themselves or the outer conductor section. Such an advantageous, direct dissipation of the heat energy would not be possible with the comparatively poor heat-conducting plastic material of the carrier. Overall higher current densities can thus be supplied to the conductor arrangement, which means that a higher continuous power is facilitated for the electrical machine, without causing a damaging level of heating of the conductor arrangement.

The conductor arrangement according to the invention is not restricted to use with specific embodiments of electrical machines, since the conductor arrangement can in principle be used in all electric motors or generators to improve heat dissipation.

In one embodiment, two outer conductor sections, each arranged parallel and opposite relative to the direction of motion can have a cross section which is greater than the cross section of the remaining conductor sections. Such a concentration of heat energy on both sides in the direction of motion of the conductor arrangement facilitates an even more improved cooling of the conductor arrangement.

Also, the outer conductor section can have a cross section which is greater than the cross section of the remaining conductor sections by multiple times. In this way, a mass of the outer conductor section can be further increased, which leads to an even better dissipation of heat energy away from the remaining conductor sections. for example the cross section of the outer conductor section can be two to ten times larger than the cross section of the remaining conductor sections.

A particularly good dissipation of heat energy away from the outer conductor section can be facilitated if the conductor strand has a uniform height. This produces, in particular for the outer conductor section, a large surface area in comparison to the remaining conductor sections, which promotes an emission of heat energy.

A particularly simple design of the conductor sections is possible if the conductor strand has a rectangular cross section. The coil is then, relative to conductor strands with round cross sections, particularly simple to produce.

In one embodiment the conductor strand can be arranged in meandering fashion and perpendicular relative to the direction of motion. This means that a winding method is not required for constructing a coil, and the coil can be designed to be flat and extend over an almost arbitrary length of the conductor arrangement with only one conductor.

In another embodiment, multiple conductor strands can be arranged in a plane of the carrier parallel to each other. The parallel arrangement of the conductor strands can facilitate a simple adaptation of the coil or coils to the power requirements of the electrical machine. For example, in this way conductor arrangements can also be designed which enable a two-phase or three-phase operation of the electrical machine.

In a further advantageous embodiment of the conductor arrangement multiple conductor strands can be constructed in parallel planes of the carrier. The fact that the conductor strands are arranged above each other in the direction of motion facilitates a coil-like structure of the conductor arrangement.

It is furthermore advantageous if the carrier comprises more than two planes, preferably 4 to 16 planes with conductor strands. The conductor arrangement can then have a very flat construction. For example, with eight planes it would have a thickness in a range of 1 to 5 mm. Due to its particularly flat construction, such a conductor arrangement can be particularly well used as a component for a linear motor. Depending on the application, an almost arbitrarily high number of planes is possible, within reason.

Uniformly shaped conductor strands of different planes can be designed to be offset relative to each other in the direction of motion. An offset can have a value of for example 60°, 90° or 120° to a magnetic period of magnetically active components. Accordingly, coils can be constructed that are offset by these amounts, which enable a continuous application of force to be produced at a constant current level.

In an extension of the conductor arrangement at least one first conductor strand can be arranged in a first plane of the carrier in meandering fashion relative to and perpendicular to the direction of motion, and furthermore at least one second conductor strand can be arranged in a second plane of the carrier in meandering fashion relative to and along the direction of motion. Such an arrangement of conductor strands perpendicular relative to each other enables a second direction of motion to be designed perpendicular to the first direction of motion. Therefore, with the conductor arrangement an electrical machine can be constructed which for example can execute a translation and a rotation at the same time, depending on the shape of the carrier. Two translational directions of motion are also conceivable, for example as part of an electrical drive for a compound table.

If the carrier of the conductor arrangement has an overlapping region, which can be made to overlap the magnetically active components, all conductor strands can be arranged at least partly in the overlapping region. Thus by means of the conductor arrangement a particularly large application of magnetic force can be achieved or utilised.

The carrier of the conductor arrangement can additionally comprise an edge region, which can be overlapped with a retaining element, wherein the edge region at least partially overlaps the outer conductor section.

Then, between the retaining element and the conductor arrangement a particularly advantageous fixing of the conductor arrangement to the retaining element can be made, since concentrated heat energy can be easily conducted away from the conductor arrangement via the retaining element in the outer conductor section.

In one embodiment the carrier of the conductor arrangement can be designed to have a straight-edged shape, for example rectangular or square. The conductor arrangement can then be used as a component for constructing a linear motor.

In a further embodiment the carrier of the conductor arrangement can have an annular design, at least in sections, for example as a complete annulus or as a segment of an annulus. Thus, by means of the conductor arrangement a torque motor can be constructed, which can execute a rotational movement, for example for a rotatable table.

In a further advantageous embodiment the carrier of the conductor arrangement can be designed to have a circular cylindrical form, at least in sections, for example in the form of a cylinder or as a segment of a cylinder. Thus, a torque motor or a linear motor with a rotatable or linearly displaceable drum can also be constructed by means of the conductor arrangement.

In the method according to the invention for producing a conductor arrangement for an electrical machine, in particular an electric motor, the conductor arrangement is formed from at least one electrical conductor and one carrier for spatially positioning the conductor, wherein a conductor strand of the conductor is arranged on at least one substrate of the carrier in the manner of a coil, wherein the conductor strand comprises conductor sections, which at least in sections are crosswise and parallel to a direction of motion of the carrier relative to magnetically active components of the electrical machine, wherein at least one outer conductor section arranged parallel to the direction of motion is designed with a cross section that is larger than the cross section of the remaining conductor sections. Heat energy produced during operation of the electrical machine in the conductor, is concentrated in the outer conductor section in such a manner that the heat energy can be particularly simply conducted away from the outer conductor section. The method according to the invention consequently facilitates the production of a conductor arrangement that can be cooled in a particularly simple manner. Moreover, the advantageous conductor arrangement is simple and therefore inexpensive to produce.

The conductor of the conductor arrangement can be constructed by means of an electrochemical method, for example by etching a circuit board. Coils can thus be constructed, which in comparison to the winding methods known from the prior art have a more uniform conductor structure with defined intervals between of conductor tracks. Also, intervals between the conductor tracks can be made particularly small and the conductor arrangement itself particularly flat.

It is particularly advantageous if the conductor is constructed on opposite surfaces of the substrate. Extraordinarily flat coils can thus be produced, which, in relation to a cross section of the conductor arrangement, comprise a particularly large proportion of electrically conducting material.

The advantageously high material density can be further increased if a plurality of substrates are joined together with dielectric layers interposed between them, in the manner of a multi-layer circuit board. A connection of such a substrate arrangement can be effected by pressing under pressure and/or applying high temperatures to the substrate arrangement. Preferably, to obtain a particularly thin conductor arrangement the conductor strands are multiple times thicker than the dielectric layer, wherein any interstices between the conductor strands are filled by the material of the dielectric layer during the pressing process. Also, the carrier can be equipped with a dielectric covering layer, which covers a surface of the conductor arrangement and so protects the conductor arrangement against undesired electrical contact.

A connection to the conductor strands can be made by means of inter-layer connections in the substrate. Inter-layer connections can be particularly simply produced and facilitate a secure electrical connection. Preferably the inter-layer connections can be constructed at the long ends of the carrier.

Further advantageous embodiments of the method follow from the feature descriptions of the dependent claims that refer back to the main device claim 1.

In the use of a conductor arrangement according to the invention during operation of an electrical machine, in particular an electric motor, the conductor arrangement is moved relative to magnetically active components of the electrical machine, the conductor arrangement being formed from at least one electrical conductor and one carrier for spatially positioning the conductor, wherein the conductor comprises conductor strands and is arranged in the manner of a coil, and wherein heat energy from the conductor arrangement is concentrated in an edge region of the conductor arrangement parallel to the direction of motion, by means of the conductor strands. In particular the concentration of heat energy in the edge region of the conductor arrangement enables an improved dissipation of the heat energy and therefore better cooling of the conductor arrangement. Due to the improved cooling of the conductor arrangement a higher continuous power of the electrical machine can be achieved.

The continuous power of the electrical machine can be increased still further if the heat energy is conducted away from the edge region of the conductor arrangement in a targeted manner. The conductor arrangement can then be designed without regard to a conductor arrangement shape that is suitable for cooling, since the cooling takes place solely in the edge region of the conductor arrangement.

Removal of heat energy is simplified when the conduction is effected by means of a retaining element. The retaining element then serves to provide the spatial positioning of the conductor arrangement and can be fixed in a planar manner to the edge region, for example by screwing the retaining element to the conductor arrangement. If a retaining element with a large thermal capacity is used, a particularly effective dissipation of heat energy away from the edge region can be achieved.

Dissipation of heat energy can also be effected by means of a fluid medium. The fluid medium can flow through the edge region of the conductor arrangement, for example by means of through openings formed, or alternatively cool the retaining element alone. Cooling can thus be further improved where gas, water or a special cooling liquid can be used as a fluid medium.

In a further embodiment dissipation of heat energy can be effected by means of a Peltier element. A Peltier element, due to its uniformly flat structure, can be particularly well connected to the edge region of the conductor arrangement or to a retaining element, and provides a low-cost cooling device.

Dissipation of heat energy can also be effected by means of a heat tube. Such a cooling device is independent of electrical energy and therefore requires no additional application or maintenance work.

Further advantageous embodiments of the method follow from the feature descriptions of the dependent claims that refer back to the main device claim 1.

Below, a preferred embodiment of the invention is described in further detail, by reference to the accompanying drawing.

In the drawings:

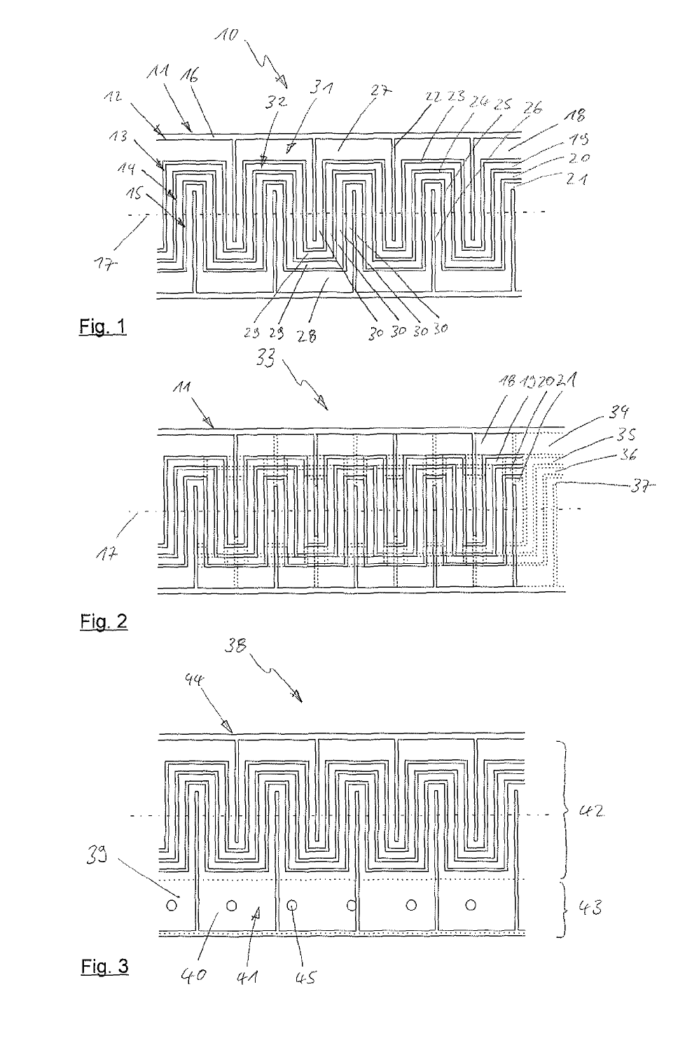

FIG. 1 shows a sectional drawing of a first embodiment of a conductor arrangement;

FIG. 2 shows a sectional drawing of a second embodiment of the conductor arrangement;

FIG. 3 shows a sectional drawing of a third embodiment of the conductor arrangement;

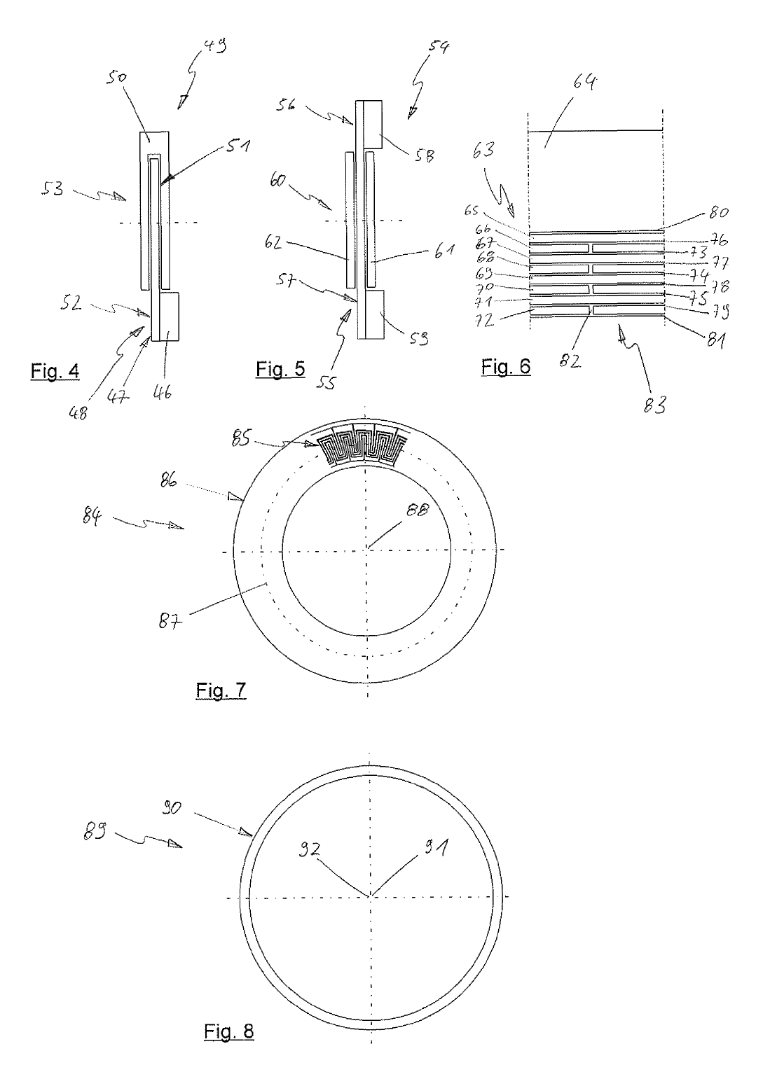

FIG. 4 shows a schematic cross-sectional drawing of a first embodiment of a linear motor;

FIG. 5 shows a schematic cross-sectional drawing of a second embodiment of a linear motor;

FIG. 6 shows a sectional cross-sectional drawing of a

fourth embodiment of the conductor arrangement with a retaining element;

FIG. 7 shows a schematic drawing of a first embodiment of a torque motor;

FIG. 8 shows a schematic drawing of a second embodiment of a torque motor.

FIG. 1 shows a first embodiment of a conductor arrangement in a sectional drawing, wherein the conductor arrangement 10 is formed from a carrier 11 and a number of electrical conductors 12, 13, 14 and 15. The carrier 11 comprises a circuit board 16 made of a dielectric material, wherein the conductors 12 to 15 consist of copper, and are of comparatively flat construction and connected to the circuit board 16. The conductors 12 to 15 are arranged substantially parallel relative to each other and extend in the direction of a possible translational motion, which is indicated with a line 17. The conductors 12 to 15 each form conductor strands 18, 19, 20 or 21 with intervening gaps 22, 23, 24, 25 or 26.

Outer conductor sections 27 and 28 of the conductor strands 18 or 21 are each arranged parallel to the line 17, that is, parallel to the direction of motion, wherein a cross section, not visible here, of the outer conductor sections and 28 is greater than a cross section of remaining conductor sections 29, extending parallel to the line 17 and conductor sections 30 extending perpendicular to the line 17. Since all conductor sections 27 to 30 have a uniform height, an area 31 of the outer conductor sections 27 and 28 is comparatively greater relative to a length of the outer conductor sections 27 or 28 than an area 32 of the conductor sections 29 or 30 in relation to length. The outer conductor sections 27 and 28 therefore have a higher thermal capacity than the conductor sections 29 and 30, so that in the event of heat developing at least in the conductor strands 18 and 21, a concentration of heat energy occurs in the outer conductor sections 27 or 28. Over the area 31 this heat can be particularly simply dissipated.

In addition, heat energy from the conductor strands 19 and 20 is transferred into the conductor strands 18 or 21, so that this heat energy can also be at least partially dissipated.

FIG. 2 shows a conductor arrangement 33, which comprises the conductor arrangement described in FIG. 1, wherein further conductor strands 34, 35, 36 and 37, here shown in dotted lines, are constructed on a rear side, not shown here, of the carrier 11. The conductor strands 34 to 37 essentially form the same shape as the conductor strands 18 to 21, wherein the conductor strands 34 to 37 are offset in the direction of the line 17, or the direction of motion, relative to the conductor strands 18 to 21. This offset is matched to a magnetic period of magnetically active components, not shown here.

A third embodiment of a conductor arrangement 38 is shown in FIG. 3, wherein the conductor arrangement 38, in contrast to the conductor arrangement of FIG. 2 comprises a conductor strand 39 with an outer conductor section 40, the cross section of area 41 of which is designed several times larger than the remaining conductor sections 27, 29 or 30. On a rear side of the conductor arrangement 38, not shown here, just such a conductor strand is constructed. The conductor arrangement 38 further comprises an overlap region 42 and an edge region 43, wherein the edge region 43 overlaps with a majority of the areas 41. The overlapping region 42 can be overlapped with magnetically active components, not shown here, of an electrical machine, for example a linear motor, wherein the edge region 43 serves to retain a carrier 44 of the conductor arrangement 38 and therefore to form a connection to a retaining element, not shown here. Through-holes 45 in the carrier 44 are provided, in particular for fixing the retaining element onto the carrier 44.

Such an arrangement with a retaining element 46 on a carrier 47, or a conductor arrangement 48, is shown in a schematic drawing of a linear motor 49 in a cross sectional view according to FIG. 4. The linear motor 49 comprises U-shaped magnetically active components 50, which form a gap 51 into which the conductor arrangement 48 is arranged so that it can be moved relative to the component 50 orthogonally to the plane of the drawing. An edge region 52 of the conductor arrangement 48 or of the carrier 47 is connected to the retaining element 46 in a planar manner, so that heat energy, which is formed inside the gap 51 in an overlap region 53 of the conductor arrangement 48, is concentrated in the edge region 52 and due to the planar contact of the retaining element 46 on the edge region 52 can be dissipated via said element.

A further embodiment of a linear motor 54 is shown in FIG. 5, wherein in this case a conductor arrangement 55 is used, which is provided with a first and second edge region 56 or with the corresponding outer conductor sections, not shown here. The edge regions 56 and 57 are each connected to a retaining element 58 or 59, so that an even further improved dissipation of heat energy from an overlapping region 60 of the conductor arrangement 55 with magnetically active components 61 and 62 can be achieved.

A cross-sectional view of a conductor arrangement 63 with a retaining element 64 is shown in a partial detail in FIG. 6. The conductor arrangement 63 is formed from conductor strands 65 to 72, which are each constructed with an intermediate dielectric layer 73 to 75 on substrates 76 to respectively. The conductor strands 65 and 72 are furthermore each provided with a dielectric covering layer to 81, so that no unintended electrical contacting of the conductor strands 65 and 72 can occur. The dielectric layers 73 to 75 and the dielectric covering layers 80 and are connected to the substrates 76 to 79 or the conductor strands 65 to 72 in such a manner that gaps 82 are completely filled by the dielectric layers 73 to 75 or and 81 and an essentially monolithic substrate arrangement 83 is formed. The conductor strands 65 to 72 are in this case several times greater in thickness than the dielectric layers, or substrates 73 to 81, so that a comparatively high proportion of, in this case, electrically conducting copper is contained in the conductor arrangement 63.

FIG. 7 shows a simplified illustration of a conductor arrangement 84 for a torque motor, which has an annular construction. Here, conductors 85, only shown schematically and in sectional form, are oriented inside a carrier 86 about a rotational axis 88 in the direction of a rotation path shown as line 87.

An alternative embodiment of a conductor arrangement 89 for a torque motor is shown in FIG. 8. The conductor arrangement 89 comprises a cylindrical carrier 90 with conductors, not visible here, arranged peripherally inside the carrier 90. The conductor arrangement 89 can be used in combination with magnetically active components as a rotor with a rotational axis 91 or as a stator. Also, it is possible to design a linear motion of the conductor arrangement 89 relative to magnetically active components along a line 92 orthogonal to the plane of the drawing.

1. A conductor arrangement for an electrical machine, said conductor arrangement being movable relative to magnetically active components of the electrical machine, the conductor arrangement being formed from at least one electrical conductor and a carrier for spatially positioning the conductor, the conductor comprising at least one conductor strand and being arranged in the manner of a coil and the conductor strand comprising conductor sections that are arranged at least in sections crosswise and parallel to a direction of motion of the carrier or the components,
wherein at least one outer conductor section arranged parallel to the direction of motion has a cross section that is greater than the cross section of the remaining conductor sections.

2. The conductor arrangement according to claim 1, wherein
two outer conductor sections arranged parallel and opposite relative to the direction of motion have a cross section that is greater than the cross section of the remaining conductor sections.

3. The conductor arrangement according to claim 1, wherein
the outer conductor section has a cross section that is several times larger than the cross section of the remaining conductor sections.

4. The conductor arrangement according to claim 1, wherein
the conductor strand has a uniform height.

5. The conductor arrangement according to claim 1, wherein preceding claims,
the conductor strand has a rectangular cross section.

6. The conductor arrangement according to claim 1, wherein
the conductor strand is arranged in meandering fashion relative and perpendicular to the direction of motion.

7. The conductor arrangement according to claim 1, wherein
multiple conductor strands are arranged parallel relative to each other in a plane of the carrier.

8. The conductor arrangement according to claim 1, wherein
multiple conductor strands are constructed in parallel planes of the carrier.

9. The conductor arrangement according to claim 8, wherein
the carrier has more than two planes with conductor strands.

10. The conductor arrangement according to claim 8, wherein
uniformly shaped conductor strands of different planes are offset relative to each other in the direction of motion.

11. The conductor arrangement according to claim 8, wherein
at least one first conductor strand is arranged in a first plane of the carrier in meandering fashion relative to and perpendicular to the direction of motion, and at least one second conductor strand is arranged in a second plane of the carrier in meandering fashion relative to and along the direction of motion.

12. The conductor arrangement according to claim 8, wherein
the carrier of the conductor arrangement comprises an overlapping region which can be made to overlap with the magnetically active components.

13. The conductor arrangement according to claim 1, wherein
the carrier of the conductor arrangement comprises an edge region which can be made to overlap with a retaining element, wherein said edge region at least partially overlaps the outer conductor section.

14. The conductor arrangement according to claim 1, wherein
the carrier of the conductor arrangement is designed with a straight-edged shape.

15. The conductor arrangement according to claim 1, wherein
the carrier of the conductor arrangement has an annular construction, at least in sections.

16. The conductor arrangement according to claim 1, wherein
the carrier of the conductor arrangement has a circular cylindrical construction, at least in sections.

17. A method for producing a conductor arrangement for an electrical machine, comprising:
the forming a conductor arrangement from at least one electrical conductor and one carrier for spatially positioning the conductor,
arranging one conductor strand of the conductor on at least one substrate of a carrier in the manner of a coil,
arranging sections of the conductor strand crosswise and parallel to a direction of motion of the carrier relative to magnetically active components of the electrical machine,
arranging at least one outer conductor section parallel to the direction of motion, the outer conductor section having with a cross section that is greater than the cross section of the remaining conductor sections.

18. The method according to claim 17,
wherein the conductor is constructed by means of an electrochemical method.

19. The method according to claim 17,
wherein the conductor is constructed on opposite surfaces of the substrate.

20. The method according to claim 19,
wherein a plurality of substrates are joined together with dielectric layers interposed between them, in the manner of a multi-layer circuit board.

21. The method according to claim 19,
wherein inter-layer connections are constructed in the substrate for connecting the conductor strands.

22. Use of a conductor arrangement during operation of an electrical machine, the conductor arrangement being moved relative to magnetically active components of the electrical machine, said conductor arrangement being formed from at least one electrical conductor and one carrier for spatially positioning the conductor, said conductor comprising conductor strands and being arranged in the manner of a coil,
wherein heat energy of the conductor arrangement is concentrated by means of the conductor strands in an edge region of the conductor arrangement located parallel to the direction of motion.

23. The method according to claim 22,
wherein the heat energy of the conductor arrangement is dissipated from the edge region.

24. The method according to claim 23,
wherein dissipation of heat energy is effected by means of a retaining element.

25. The method according to claim 23, wherein
dissipation of heat energy is effected by means of a fluid medium.

26. The method according to claim 23, wherein,
dissipation of heat energy is effected by means of a Peltier element.

27. The method according to claim 23, wherein or 24,
dissipation of heat energy is effected by means of a heat tube.
